(19) United States
(12) Patent Application Publication
(10) Pub. No.: US 2008/0215894 A1
(43) Pub. Date: Sep. 4, 2008

(54) Method, System and Devices For Digital Content Protection

(75) Inventors: Henricus Antonius Wilhelmus Van Gestel, Eindhoven (NL); Sebastiaan Antonius Fransiscus Arnold Van Den Heuvel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,424

(22) PCT Filed: Jun. 29, 2006
(86) PCT No.: PCT/IB06/52175

§ 371 Date: Jan. 2, 2008

(30) Foreign Application Priority Data
Jul. 5, 2005 (EP) 05106089.5

(51) Int. Cl. G06F 21/00

(52) U.S. Cl. 713/189

(57) ABSTRACT

This invention relates to a system (and a corresponding method and devices) of digital content protection the system comprising a first digital content protection system (101) comprising a digital content item (106), a content access device (105) outside of the first digital content protection system (101), and at least one intermediary device (100) for providing said content access device (105) access to said digital content item (106) of said first digital content protection system (101), and where the intermediary device (100) is configured to generate secure access information (Encr(K;Inf_ID)), using a secret (K) known to the intermediary device (100), to enable the intermediary device (100) to recover the access information (Inf ID), and where the intermediary device (100) is further configured to use said access information (Inf ID) to enable said content access device (105) to access said digital content item (106) within said first digital content protection system (101).

The present invention relates to a method of providing access to a digital content item in a digital content protection system. The invention further relates to a system for digital content protection. Further, the invention relates to a computer readable medium having stored thereon instructions for causing one or more processing units to execute the method according to the invention. Additionally, the present invention relates to an intermediary device for providing a content access device access to a digital content item and to a content access device providing access to a digital content item in a digital content protection system.

Recent developments in content distribution technologies (e.g. the Internet, mobile connectivity, removable media, etc.) make it much easier to exchange content than ever before. The rapid adoption by consumers shows that such technologies really address their needs. The content providers want protection of the copyright of the content/content item(s) that is brought into digital circulation. Therefore in recent years, the amount of content protection systems is growing at a rapid pace. One category of content protection systems is usually referred to as Copy Protection (CP) systems. CP systems have traditionally been the main focus for consumer electronics (CE) devices, as this type of content protection is thought to be cheaply implemented and does not need bi-directional interaction with the content provider. Some examples are the Content Scrambling System (CSS), the protection system of DVD ROM discs and DTCP (a protection system for IEEE 1394 connections). Another category is known under several names. In the broadcast world, systems of this category are generally known as conditional access (CA) systems, while in the Internet world they are generally known as Digital Rights Management (DRM) systems or platforms. In the following such systems and methods will be referred to as digital content protection systems.

(Domain based) digital content protection systems usually have one very typical characteristic. Namely, that the right(s) to a given content item usually differ depending on the particular device that the content is being accessed on and/or the state of the device. As examples: it may depend on the type of device, where it is located (i.e. inside or outside the domain), what the device is connected to, which users have authenticated themselves to the device, etc. More rights are typically granted in the case that the content is accessed on a device within the domain than when the content is accessed on a device outside the domain (which typically requires a copy of the content item). As examples of typical rights granted on a device within the domain are e.g. copying, distributing to other devices (within the domain), access for several users and/or the like. As examples of typical rights granted on a device outside the domain is e.g. (limited) access/rendering/viewing only (i.e. no copy), access only for a specific user, no distribution to other devices, and/or the like.

Digital content protection systems can be designed or directed at certain users, uses and/or types of user devices. One example is e.g. digital content protection systems directed at mobile communications or mobile connectivity. Another example is e.g. digital content protection systems directed at digital home entertainment systems. A further example is e.g. digital content protection systems allowing content being distributed over many different delivery systems to be available to a number of devices.

A user may have access to several different digital content protection systems, e.g. one digital content protection system responsible for providing content for mobile platforms and one responsible for providing home entertainment in a secure manner or simply two or more digital content protection systems from different content providers.

A device will typically be responsible for handling the communications between different digital content protection systems when a device in one digital content protection system needs access to content in another digital content protection system or, generally, responsible for handling the communications between a device that seeks access to content in a given content protection system. Such a device is usually referred to as a converter, a gateway, a conversion-, transformation-, translation-, mutation-, interpretation-, interaction-, or intermediary device or the like and is referred to as an intermediary device in the following.

When a user wants to access content in a first type of digital content protection system from (a device in) a second type of digital content protection system then traditionally the specific content usually has to be securely imported into the second type digital content protection system (e.g. by an interoperability digital content protection system or directly) or at least be brought into control of the second type digital content protection system before proper access is possible. This process may involve conversion or translation of rights, handling of security during the actual transfer of the content, etc. and is quite complex since rights, security measures and levels, device and user authentication, etc. may be implemented in very different ways in the two digital content protection systems. As an example, one type of digital content protection system may only involve rights without a state (i.e. either granting access to a given content item or not) while the other type of digital content protection system may involve rights with a state or countable rights (i.e. the user is only granted access to a given content item a number times or for a given period of time before additional uses/accesses or time must be purchased) or the rights may simply be implemented in different ways.

It is preferred that the device that is responsible for handling access between the digital content protection systems is stateless, i.e. it does not have information relating to the content protection system(s) stored on it. To achieve this in an efficient and secure way is not straightforward. If the devices are not stateless they will also require communications between them when a new intermediary device is used, which may be further complicated if the intermediary devices are from different manufacturers. Further, storage of such information on various intermediary devices would also require some administration. Such intermediary devices may e.g. be a gateway, hotspot, access point or the like to a network where content is available and under control of a type of digital content protection system.

It is an object of the invention to provide transparent access to content in a first digital content protection system to a content access device outside of the first digital content protection system, while the content remains under control of the first digital content protection system.

This object is achieved by a system (and corresponding devices and a method) for digital content protection, the system comprising: a first digital content protection system comprising a digital content item, a content access device that is not part of the first digital content protection system, and at least one intermediary device for providing said content access device access to said digital content item of said first digital content protection system, and where the intermediary device is configured to generate secure access information for storage on said content access device, using a secret known to the intermediary device, that enables the intermediary device to recover access information from said secure access information stored on said content access device, and where the intermediary device is further configured to use said access information to enable said content access device to access said digital content item within said first digital content protection system.

In this way, stateless intermediary devices and security (without the need for secure storage of the access information on the content access device) is obtained in a very simple and efficient way.

By storing the access information on the content access device outside the first digital content protection system it is ensured that the intermediary device is stateless without comprising security. Keeping the intermediary device(s) stateless provides simplicity and avoids inconsistency of state. Further, different intermediary devices need not have their state aligned as would otherwise be required.

A further advantage of such a stateless intermediary device is that the user does not have to connect to the same intermediary device since the relevant information is obtainable elsewhere. Additionally, by keeping them stateless a content access device can use multiple different intermediary devices without requiring the different intermediary devices to communicate. Normally, and especially if the involved digital content protection system comprises mobile consumer electronic (CE) devices, a user will connect to different such intermediary devices during normal use. Further, by keeping such intermediary devices stateless duplication of information is avoided since each intermediary device does not need to have the information that is needed to enable a device in one digital content protection system to act as a device in another digital content protection system stored locally.

Further, when a content access device in a second digital content protection system accesses content in a first digital content protection system then the actual content is not “copied” to the second digital content protection system, thereby reducing storage requirements and in some uses also saving bandwidth.

In one embodiment, the secure access information is generated by encrypting it.

In one embodiment, the content access device is located in a second digital content protection system.

In an alternative embodiment, the content access device is located in an interoperability digital content protection system, a system that addresses interoperability issues between at least two digital content protection systems.

In one embodiment, a shared key used by devices within said first digital content protection system is used for encrypting the access information thereby allowing additional intermediary devices to recover the access information since they can also obtain the shared key. Alternatively in case the content access device is in a second digital content protection system a shared secret key from the second digital content protection system can be used. The intermediary device effectively has access to both the first and the second digital content protection system, and could be granted access to shared keys from either domain. In this way, reuse of an already existing key is obtained such that the need for key generation is avoided. Further, it is allowed that different intermediary devices can recover the access information since the encryption key is shared.

In one embodiment, the access information is stored on the content access device by a given intermediary device in a secure way by encrypting it with an encryption key that is unique for the content access device resulting in encrypted access information and encrypting and storing on the content access device the encryption key encrypted with a public key of a public and private key pair of the intermediary device or with a symmetrical key of the intermediary device so that the intermediary device is able to decrypt the encryption key and thereby obtain said stored access information.

Further, there is no need of a shared secret for the various content access devices, which then do not require agreement between the many different manufacturers of content access devices for one implementation or design.

Since the key used in encrypting the access information is unique for the content access device it is ensured that each intermediary device only needs to contact an ID service once per connecting content access device as it can retrieve the access information from the content access device henceforth (while still preserving security).

In one embodiment, the access information is stored on the content access device in a secure way by encrypting it with a public key of a public and private key pair of the intermediary device or with a symmetrical key of the intermediary device so that only the given intermediary device that stored said access information on the content access device is able to obtain it. The above-mentioned advantages for the previous embodiment also apply for this embodiment.

Further, the invention also relates to a method of providing access for a content access device to a digital content item in a first digital content protection system where the content access device is not part of the first digital content protection system, the method comprising the steps of: providing access for said content access device to said digital content item by an intermediary device, where the intermediary device has generated secure access information for storage on said content access device, using a secret known to the intermediary device, that enables the intermediary device to recover access information from said secure access information stored on said content access device, obtaining said access information by the intermediary device, and using said access information to enable said content access device to access said digital content item within said first digital content protection system.

Advantageous embodiments of the method according to the present invention are defined in the sub-claims and described in detail in the following. The embodiments of the method correspond to the embodiments of the system and have the same advantages for the same reasons.

The present invention also relates to an intermediary device and a content access device as given in the claims and in the following.

Further, the invention also relates to a computer readable medium having stored thereon instructions for causing one or more processing units to execute the method according to the present invention.

These and other aspects of the invention will be apparent from and elucidated with reference to the illustrative embodiments shown in the drawings, in which:

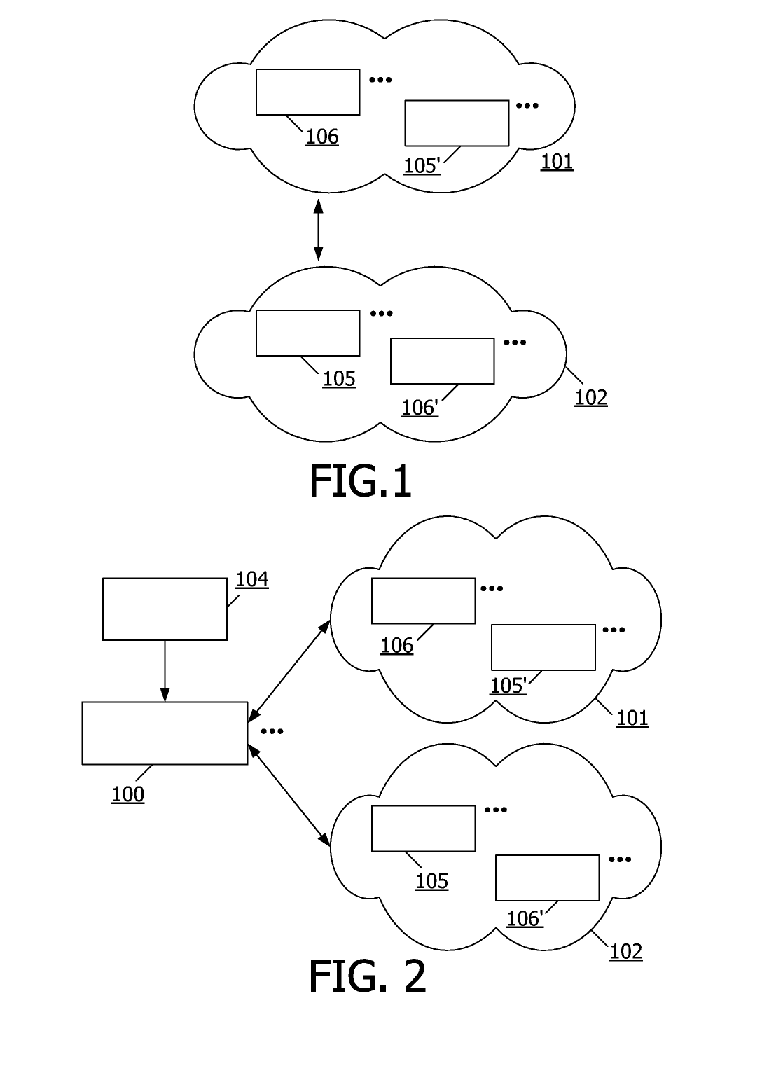

FIG. 1 schematically illustrates access to a digital content item in a first digital content protection system by a content access device in a second digital content protection system according to prior art;

FIG. 2 schematically illustrates access to a digital content item in a first digital content protection system by a content access device in a second digital content protection system or at least being outside a first digital content protection system according to one embodiment of the present invention;

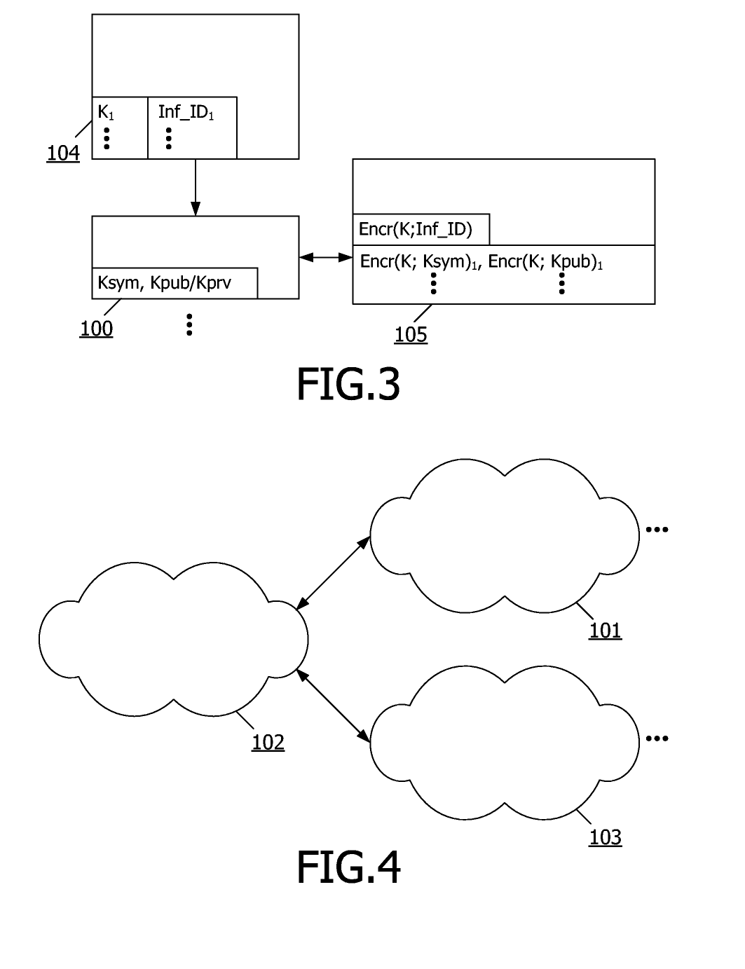

FIG. 3 schematically illustrates the data stored by a device in a second digital content protection system or at least being outside a first digital content protection system, an ID service, and an intermediary device;

FIG. 4 schematically illustrates three digital content protection systems where one is an interoperability digital content protection system; and

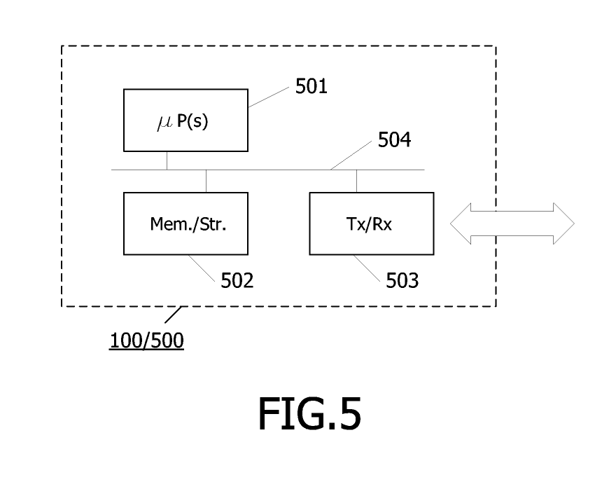

FIG. 5 illustrates a schematic block diagram of a content access device or an intermediary device providing the content access device access to a digital content item in another digital content protection system.

FIG. 1 schematically illustrates access to a digital content item in a first digital content protection system by a content access device in a second digital content protection system according to prior art. Shown is a first type of digital content protection system (101) that comprises at least one digital content item (106) and 0 or more content access devices (105′) being within the domain, i.e. under the control of, the first digital content protection system (101). Further shown is a second type of digital content protection system (102) that comprises at least one content access device (105) and 0 or more content items (106′). Normally, the devices belonging to a given digital content protection system can access content items belonging to the same content protection system. New content is brought into the domain of the given digital content protection system according to the specific implementation of the content protection system but in a securely manner. The given digital content protection system also regulates which access is granted and how for users and/or devices outside the domain of the specific digital content protection system.

When a device of one digital content protection system, e.g. the second digital content protection system (102) wants to access a content item of another digital content protection system, e.g. the first digital content protection system (101), then the specific content usually has to be securely imported into the second digital content protection system or at least be brought into control of the second digital content protection system before secure access is possible. As mentioned earlier, this process is quite complex since rights, security measures and levels, device and user authentication, etc. may be implemented in very different ways in the two systems. Examples of such prior art systems are e.g. CPSA (http://sharedserv.no-ip.org/drm/sepy/CPSA.html) that provide a way to do translation without the use of an intermediary device and Coral (http://www.coral-interop.org/).

FIG. 2 schematically illustrates access to a digital content item in a first digital content protection system by a content access device in a second digital content protection system or at least outside the first system according to one embodiment of the present invention. Shown are a first digital content protection system (101) comprising at least one digital content item (106) and 0 or more content access devices (105′) under the control of the first digital content protection system (101) and a second digital content protection system (102) comprising at least one content access device (105) and 0 or more content items (106′). Further shown is at least one intermediary device (100) for providing the content access device (105) of the second digital content protection system (102) access to the at least one digital content item (106) of the first digital content protection system (101). Also shown is an ID service (104) for providing individual access information (Inf_ID; not shown; see FIG. 3) enabling the content access device (105) access to the digital content item(s) (106) within the first digital content protection system (101). The individual access information (Inf_ID) may e.g. comprise one or more of a device ID number, a certificate, encryption keys needed for accessing content of the first digital content protection system, rights issuer context, domain contexts, purchased rights and/or the like being in compliance with the first digital content protection system. The information in the first digital content protection system (101) and information from and to the ID service (104) is should be handled in a secure manner so security is not breached by transmitting this information.

On a first connection between a given content access device (105) of the second digital content protection system (102) and a given intermediary device (100), i.e. when the given access device tries to access a given content item (106) within the first digital content protection system for the first time, access information (Inf_ID) enabling the content access device (105) to access the digital content item(s) (106) within the first digital content protection system (101) is obtained from the ID service (104). The obtained access information is then, in one embodiment, encrypted using a secret key (K, not shown; see FIG. 3) preferably also obtained from the ID service (104) (or another service). The secret key (K) may be generated by the ID service (104) when the access device connects and registers e.g. using its own ID (within the second digital content protection system) thereby effectively binding the generated secret key (K) to the specific content access device and to the specific access information (Inf_ID). The secret key (K) is unique for the access device (105) (but shared between or obtainable by various intermediary devices as explained later). In a preferred embodiment the secret key (K) is obtained by applying a one-way function to the specific access information (Inf_ID). This information (K and Inf_ID) is not stored on the given intermediary device (100) in order to keep it stateless. Alternatively, the information or at least part of it could be stored on the given intermediary device and the key is then used to encrypt the common info on the device so more than one intermediary device can utilize it.

The secret key (K) is then encrypted in such a way that only the intermediary device (100) that stored it on the content access device is able to decrypt and obtain it again in order to preserve security. This can be done by encrypting it with a public key (Kpub) of a public/private key pair (Kpub, Kprv) of the intermediary device (100) or with a secret symmetric key (Ksym) or other key secret to the intermediary device (100) or in another secure way.

When the same content access device (105) of the second digital content protection systems connects with another intermediary device (100) the same secret key (K) retrieved from the ID service (104) (as the key (K) effectively is bound to the specific content access device) and is encrypted with that particular intermediary device's secret key and stored. In this way, the content access device (105) will only have the access information (Inf_ID) stored once (encrypted with the secret key (K) of the content access device (105)) but will store the secret key (K) once for each intermediary device (100) it has connected to encrypted with the specific intermediary device's secret key. This saves storage, especially when the access information (Inf_ID) is larger than the encrypted secret key (K), which usually is the case, while maintaining security on the content access device (105) in a simple way.

As a result, each intermediary device (100) where the content access device (105) has been registered can access the secret key (K) using its own private or secret key (Kprv, Ksym) and subsequently use the decrypted secret key (K) to obtain the access information (Inf_ID) whereby the content access device (105) can act (transparently to the first digital content protection system) as a device in that domain and access the content items of it.

In this way, stateless intermediary devices (100) and security (without the need for secure storage on the content access device (105)) of the access information (Inf_ID) is obtained in a very simple and efficient way. Additionally, each intermediary device (100) only needs to contact the ID service (104) once per connecting content access device (105). Further, there is no need of a shared secret for the various content access devices which then do not require agreement between the many different manufacturers of content access devices for one implementation or design.

In an alternative embodiment, the secret key (K) is not generated or used. In this embodiment, the access information (Inf_ID) information is simply encrypted with a key related to the intermediary device (100) that stored it (e.g. using a public key (Kpub) or a secret symmetric key (Ksym) or the like). This still leaves the intermediary devices (100) stateless and also provide the necessary security but the access information (Inf_ID) information is stored once for each intermediary device (100).

In another alternative embodiment, another existing key may be (re-) used (e.g. a key for content protection for content (105′) in the second content protection system).

The ID service (104), the intermediary device (100) and the content access device (105) of the second digital content protection system (102) in combination will function as a content access device (105′) in the first digital content protection system (101). Further, the ID service (104), the intermediary device (100) and the content access device (105′) of the first digital content protection system (101) in combination will function as a content access device (105) in the second digital content protection system (102).

In one embodiment, a shared key from the first digital content protection system (102) is used as shared secret encryption key K. Alternatively, a shared key from the second digital content protection system (101) is used as shared secret encryption key K provided that security is properly handled.

Examples of a content access device (105) are e.g. audio and/or video playback devices, rendering devices, television sets, digital video systems, music sets, mobile telephones, PDAs, laptops, PCs, CE devices, in-car entertainment systems, and etc. capable of wired and/or wireless communication with the digital content protection system(s) via a suitable network.

There also exists digital content protection systems, which primary function is to facilitate communication, transfer, access, etc. between several digital content protection systems. Such digital content protection systems are typically referred to as interoperability digital content protection systems. Interoperability digital content protection systems are especially advantages in relation to CE devices as it often is not possible to incorporate a large amount of various digital content protection systems due to its more limited capabilities like storage, processing power, etc. Such interoperability systems are explained in greater detail in connection with FIG. 4.

As an example, the first digital content protection system can e.g. be an OMA (Open Mobile Alliance) DRM V2.0 system e.g. as described http://www.openmobilealliance.org/release_program/docs/DRM/V2_{—}0-20050614-C/OMA-DRM-ARCH-V2_{—}0_{—}6-2004082-C.pdf, incorporated herein by reference.

It is also to be understood that it is possible to have systems that have multiple ID services and/or multiple intermediary devices.

Please note that although the present invention has been explained with the content access device being part of the second content protection system this is not required and the present invention is also applicable with the same advantages to devices simply being outside the first content protection system.

FIG. 3 schematically illustrates the data stored by a device being outside a first digital content protection system (e.g. in a second digital content protection system), an ID service, and an intermediary device according to one embodiment of the present invention.

Shown are an ID service (104) comprising one or more secret key(s) (K(s)) and one or more content access information (Inf_ID(s)) (one of each for each registered content access device in the second digital content protection system), an intermediary device (100) storing an encryption key e.g. in the form of a secret symmetrical key (Ksym) or a public/private key pair (Kpub/Kprv) or another type of secret known only to itself, and a content access device (105) being outside the first digital content protection system storing the access information (Inf_ID) encrypted by the secret key (K) bound to it and one encryption key (Ksym; Kpub) for each intermediary device (100) that the content access device (105) has registered with where the secret keys (K(s)) are encrypted by the encryption key of their respectively intermediary device (100), as explained in connection with FIG. 2.

Alternatively, at the content access device (105) the access information (Inf_ID) is simply encrypted with an encryption key being specific to the intermediary device (100) and stored for each intermediary device it has registered with.

FIG. 4 schematically illustrates three digital content protection systems where one is an interoperability digital content protection system. Shown are at least one first digital content protection system (101) and a second digital content protection system (102) according to the present invention. The second digital content protection system (102) is in this particular embodiment an interoperability digital content protection system that functions as described above but where the content access device further can provide access to the digital content item of the first digital content protection system (101) to at least one additional content protection system or digital content protection system (103). As an example, the first digital content protection system may e.g. be a digital content protection platform related at providing content to mobile CE devices and the additional digital content protection system (103) may e.g. be a Microsoft Windows® DRM system. In this way, the interoperability digital content protection (102) provides seamless access to the additional digital content protection system (103) without compromising security and without the need to transfer the content to or bring the content item under the control of the additional digital content protection system (103). When the additional digital content protection system (103) needs to access a content item of the first digital content protection system (101) a request is sent to the content access device of the interoperability digital content protection system (102) that can provide access to the content item in the same way as described above in connection with FIGS. 2 and 3. Having such an interoperability digital content protection system (102) provides access to content with the already mentioned advantages and avoids the need for the various providers of the additional digital content protection systems (103) to be compatible.

FIG. 5 illustrates a schematic block diagram of a device (500) that could be configured either as a content access device (105) or an intermediary device (100) for providing the content access device access to a digital content item in another digital content protection system. Shown is a device (500) comprising one or more specialized and/or generalized micro processors (501) implementing the functionality as described in connection with the present invention, where the one or more processors are connected via a bus or similar data communication structure (504) with a memory and a storage (502) and transmitter/receiver (503) for storing and communication of information, data, etc., respectively, according to the present invention.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A system for digital content protection, the system comprising:
a first digital content protection system (101) comprising a digital content item (106),
a content access device (105) that is not part of the first digital content protection system (101), and
at least one intermediary device (100) for providing said content access device (105) access to said digital content item (106) of said first digital content protection system (101), and
where the intermediary device (100) is configured to generate secure access information for storage on said content access device (105), using a secret (K) known to the intermediary device (100), that enables the intermediary device (100) to recover access information (Inf_ID) from said secure access information stored on said content access device (105), and where the intermediary device (100) is further configured to use said access information (Inf_ID) to enable said content access device (105) to access said digital content item (106) within said first digital content protection system (101).

2. A system according to claim 1, wherein said secure access information (Encr(K;Inf_ID)) is generated by encrypting it.

3. A system according to claim 1, wherein said content access device (105) is located in a second digital content protection system (102).

4. A system according to claim 1, wherein said content access device (105) is located in an interoperability digital content protection system (102).

5. A system according to anyone of claim 2, wherein a shared key is used for encrypting the access information (Inf_ID) thereby allowing additional intermediary devices (100) to recover the access information (Inf_ID).

6. A system according to claim 1, wherein said access information (Inf_ID) is stored on the content access device (105) by a given intermediary device (100) in a secure way by encrypting it with an encryption key (K) that is unique for the content access device (105) resulting in encrypted access information (Encr(K,Inf_ID)) and encrypting and storing on the content access device (105) the encryption key (K) encrypted with a public key (Kpub) of a public and private key pair (Kpub,Kpriv) of the intermediary device (100) or with a symmetrical key (Ksym) of the intermediary device (100) so that the intermediary device (100) is able to decrypt the encryption key (K) and thereby obtain said stored access information (Inf_ID).

7. A system according to claim 6, wherein the secret (K) is generated by an ID service (104).

8. A system according to claim 7, where the secret (K) is generated by applying a one-way function to said access information (Inf_ID).

9. A system according to claim 1, wherein said access information (Inf_ID) is stored on the content access device (105) in a secure way by encrypting it with a public key (Kpub) of a public and private key pair (Kpub,Kpriv) of the intermediary device (100) or with a symmetrical key (Ksym) of the intermediary device (100) so that only the given intermediary device (100) that stored said access information (Inf_ID) on the content access device (105) is able to obtain it.

10. An intermediary device (100) for providing a content access device (105) access to a digital content item (106) of a first digital content protection system (101), where said first digital content protection system (101) comprises the digital content item (106) and said content access device (105) is not part of the first digital content protection system (101), and wherein the intermediary device (100) is configured to generate secure access information for storage on said content access device (105), using a secret (K) known to the intermediary device (100), that enables the intermediary device (100) to recover the access information (Inf_ID) from said secure access information stored on said content access device (105), and where the intermediary device (100) is further configured to use said access information (Inf_ID) to enable said content access device (105) to access said digital content item (106) within said first digital content protection system (101).

11. A content access device (105) for obtaining access to a digital content item (106) in a first digital content protection system (101), the content access device (105) being outside the first digital content protection system (101), where the content access device (105) having stored secure access information generated by an intermediary device (100) and enabling said content access device (105) to access said digital content item (106) in a secure way using a secret known to the intermediary device (100).

12. A method of providing access for a content access device (105) to a digital content item (106) in a first digital content protection system (101) where the content access device (105) is not part of the first digital content protection system (101), the method comprising the steps of:
providing access for said content access device (105) to said digital content item (106) by an intermediary device (100), where the intermediary device (100) has generated secure access information for storage on said content access device (105), using a secret (K) known to the intermediary device (100), that enables the intermediary device (100) to recover access information (Inf_ID) from said secure access information stored on said content access device (105),
obtaining said access information (Inf_ID) by the intermediary device (100), and
using said access information (Inf_ID) to enable said content access device (105) to access said digital content item (106) within said first digital content protection system (101).

13. A method according to claim 12, wherein said secure access information (Encr(K;Inf_ID)) is generated by encrypting it.

14. A method according to claim 12, wherein said content access device (105) is located in a second digital content protection system (102).

15. A method according to claim 12, wherein said content access device (105) is located in an interoperability digital content protection system (102)

16. A method according to anyone of claim 13, wherein a shared key is used for encrypting the access information (Inf_ID) thereby allowing additional intermediary devices (100) to recover the access information (Inf_ID).

17. A method according to claim 12, wherein the method comprises:
storing said access information (Inf_ID) on the content access device (105) by a given intermediary device (100) in a secure way by encrypting it with an encryption key (K) that is unique for the content access device (105) resulting in encrypted access information (Encr(K,Inf_ID)),
encrypting and storing on the content access device (105) the encryption key (K) encrypted with a public key (Kpub) of a public and private key pair (Kpub,Kpriv) of the intermediary device (100) or with a symmetrical key (Ksym) of the intermediary device (100) so that the intermediary device (100) is able to decrypt the encryption key (K) and thereby obtain said stored access information (Inf_ID).

18. A method according to claim 17, wherein the secret (K) is generated by an ID service (104).

19. A method according to claim 18, where the secret (K) is generated by applying a one-way function to said access information (Inf_ID).

20. A method according to claim 12, wherein the method comprises:
storing said access information (Inf_ID) on the content access device (105) in a secure way by encrypting it with a public key (Kpub) of a public and private key pair (Kpub,Kpriv) of the intermediary device (100) or with a symmetrical key (Ksym) of the intermediary device (100) so that only the given intermediary device (100) that stored said access information (Inf_ID) on the content access device (105) is able to obtain it.

21. A computer readable medium having stored thereon instructions for causing one or more processing units to execute the method according to claim 12.
